(19) United States
(12) Patent Application Publication
(10) Pub. No.: US 2024/0330634 A1
(43) Pub. Date: Oct. 3, 2024

(54) IMAGE RECORDING DEVICE

(71) Applicant: BROTHER KOGYO KABUSHIKI KAISHA, Nagoya (JP)

(72) Inventor: Hironori TAKASAKI, Ogaki (JP)

(73) Assignee: BROTHER KOGYO KABUSHIKI KAISHA, Nagoya (JP)

(21) Appl. No.: 18/624,692

(22) Filed: Apr. 2, 2024

(30) Foreign Application Priority Data
Apr. 3, 2023 (JP) 2023-060381

(51) Int. Cl. G06K 15/00; G09B 19/00

(52) U.S. Cl. CPC G06K 15/4065; G06K 15/005; G09B 19/003

(57) ABSTRACT

An image recording device includes: a housing; a tray configured to be attached to and detached from the housing; a recording device configured to record an image on a sheet supplied from the tray; a display; and a controller. The tray includes: a first region configured to allow at least one first type of sheet to be placed therein; and a second region configured to allow a second type of sheet to be placed therein, the second type of sheet being different from the first type of sheet and prepared in a rolled state. The controller is configured to execute a process of causing the display to display thereon a sheet placing screen indicating which of the first region and the second region the sheet is to be placed in.

### REFERENCE TO RELATED APPLICATIONS

This application claims priority from Japanese Patent Application No. 2023-060381 filed on Apr. 3, 2023. The entire content of the priority application is incorporated herein by reference.

### BACKGROUND ART

The present disclosure relates to an image recording device that is capable of displaying a method for placing a cut sheet or a sheet wound in a roll shape on a tray.

A paper feeder using a tray having placement positions (regions) corresponding to two types of paper, namely, cut paper and roll paper, has been proposed (for example, see JPH02-264556A). By using the tray having the placement positions (the regions) corresponding to the two types of paper, it is possible to increase variations of paper which can be supplied by the paper feeder without increasing the size of the paper feeder.

### DESCRIPTION

The shapes and the placement positions of the two types of sheets (paper) are different, and thus methods for placing the two types of sheets on the tray and conveyance paths (supply passages) on the tray are also different. When the sheet is not appropriately placed on the tray, the sheet may be a cause of occurrence of a jam in supply. It is preferable that an appropriate placement method can be guided for each sheet.

The present disclosure has been made in view of the above circumstances, and an object thereof is to provide an image recording device capable of guiding an appropriate placement method on a tray for each sheet.

(1) An image recording device of the present disclosure includes: a housing; a tray configured to be attached to and detached from the housing; a recording device configured to record an image on a sheet supplied from the tray; a display; and a controller. The tray includes: a first region configured to allow at least one first type of sheet to be placed therein; and a second region configured to allow a second type of sheet to be placed therein, the second type of sheet being different from the first type of sheet and prepared in a rolled state. The controller is configured to execute a process of causing the display to display thereon a sheet placing screen indicating which of the first region and the second region the sheet is to be placed in.

According to the above configuration, with respect to the tray on which both the first type of sheet and the second type of sheet can be placed, the display displays thereon the sheet placing screen indicating which of the first region and the second region the sheet is to be placed in. By visually indicating which of the first region and the second region the sheet is placed in, a user can easily grasp a place at which the sheets are placed.

(2) The controller may be configured to execute a process of causing the display to display thereon a first guidance indicating a procedure of placing the at least one first type of sheet in the first region.

According to the above configuration, the guidance indicating the procedure of placing the first type of sheet in the first region is displayed on the display. By visually indicating the procedure of placing the first type of sheet in the first region, the user can easily grasp the place at which the first type of sheet is placed.

(3) The controller may be configured to execute a process of causing the display to display thereon a second guidance indicating a procedure of placing the second type of sheet in the second region.

According to the above configuration, the guidance indicating the procedure of placing the second type of sheet in the second region is displayed on the display. The procedure of placing the second type of sheet in the second region can be visually indicated, and the user can easily grasp a place at which the second type of sheet is placed.

(4) The controller may be configured to: execute, in response to reception of a trigger signal, a process of causing the display to display thereon a sheet input screen for receiving an input designating a type of sheet; execute, in response to reception of an input designating the first type, a process of causing the display to display thereon a first guidance indicating a procedure of placing the at least one first type of sheet in the first region; and execute, in response to reception of an input designating the second type, a process of causing the display to display thereon a second guidance indicating a procedure of placing the second type of sheet in the second region.

According to the above configuration, the first guidance or the second guidance corresponding to the type of sheet input in accordance with the sheet input screen is displayed on the display. By visually indicating different placement procedures depending on the sheet, an appropriate placement method on the tray is guided.

(5) The image recording device may further include a roller configured to supply the sheet from the tray. The tray may include: a support plate located in the first region and defining a passage below the support plate, the passage extending from the second region; and a switching member supported by the support plate and configured to move between a first position and a second position, the second position at which the switching member exposes a part of the passage. When no sheet is placed in the first region, the switching member at the first position may allow the roller to contact the switching member, and the switching member at the second position may allow the roller to access the passage without contacting the switching member. The first guidance may include a screen indicating that the switching member is located at the first position, and the second guidance may include a screen indicating that the switching member is located at the second position.

According to the above configuration, it is possible to provide an appropriate guide for determining a position of the switching member according to the type of sheet to be placed.

(6) The tray may include a support plate located in the first region and defining a passage below the support plate, the passage extending from the second region, and the second guidance may include a screen indicating that a leading end of the second type of sheet enters the passage.

(7) The first guidance may include a screen indicating that no sheet is placed in the second region.

According to the above configuration, it is possible to provide an appropriate guide for selectively placing the first type of sheet or the second type of sheet.

(8) The second guidance may include a screen indicating that no sheet is placed in the first region.

According to the above configuration, it is possible to provide an appropriate guide for selectively placing the first type of sheet or the second type of sheet.

(9) The tray may include a side guide configured to move in a direction intersecting a direction in which the sheet is supplied, the side guide being configured to contact the first type of sheet placed in the first region, and the first guidance may include a screen indicating that the side guide is moved.

According to the above configuration, it is possible to reduce occurrence of a misalignment in the supply of the first type of sheet placed in the first region.

(10) The tray may include a protrusion that is located at an end portion of the tray in a supply direction of the sheet and protrudes upward, and the second guidance may include a screen indicating that the leading end of the second type of sheet, which has entered the passage, contacts the protrusion.

According to the above configuration, it is possible to position the leading end of the second type of sheet pulled out from the second region.

(11) The tray may include a side guide configured to move in a direction intersecting a direction in which the sheet is supplied, the side guide being configured to contact the second type of sheet, and the second guidance may include a screen indicating that the side guide is moved.

According to the above configuration, it is possible to reduce occurrence of a misalignment in the supply of the second type of sheet placed in the second region.

(12) The image recording device may further include: a first discharge tray configured to support the sheet on which the image is recorded; and a second discharge tray configured to move in a discharge direction of the sheet with respect to the first discharge tray. The second guidance may include a screen indicating that the second discharge tray is moved in a direction opposite to the discharge direction.

According to the above configuration, it is possible to reduce occurrence of prevention of discharge of the second type of sheet caused by the sheet being caught by the first discharge tray and the second discharge tray.

(13) The image recording device may further include a sensor configured to detect attachment and detachment of the tray. The trigger signal may include a signal from the sensor indicating that the tray is detached.

According to the above configuration, the first guidance or the second guidance is visually guided in response to the state, as a trigger, that the first region and the second region can be accessed from the outside.

(14) Each of the first guidance and the second guidance may include a plurality of screens. The controller may be configured to: execute a process of measuring a first elapsed time after a screen included in the first guidance or the second guidance is displayed on the display and a second elapsed time after the sheet input screen is displayed on the display, and execute, in response to the first elapsed time reaching a first predetermined time or the second elapsed time reaching a second predetermined time, a process of causing the display to display thereon a screen displayed before the trigger signal is received on the display. The first predetermined time may be longer than the second predetermined time.

According to the above configuration, a time in which the procedure of placing the sheet on the tray can be confirmed becomes long.

(15) The sheet placing screen may include an image indicating a type of sheet and an image indicating the tray in which the first region and the second region are drawn.

According to the above configuration, a positional relation between the tray and the sheet can be easily grasped.

According to the present disclosure, an appropriate sheet placement method is guided.

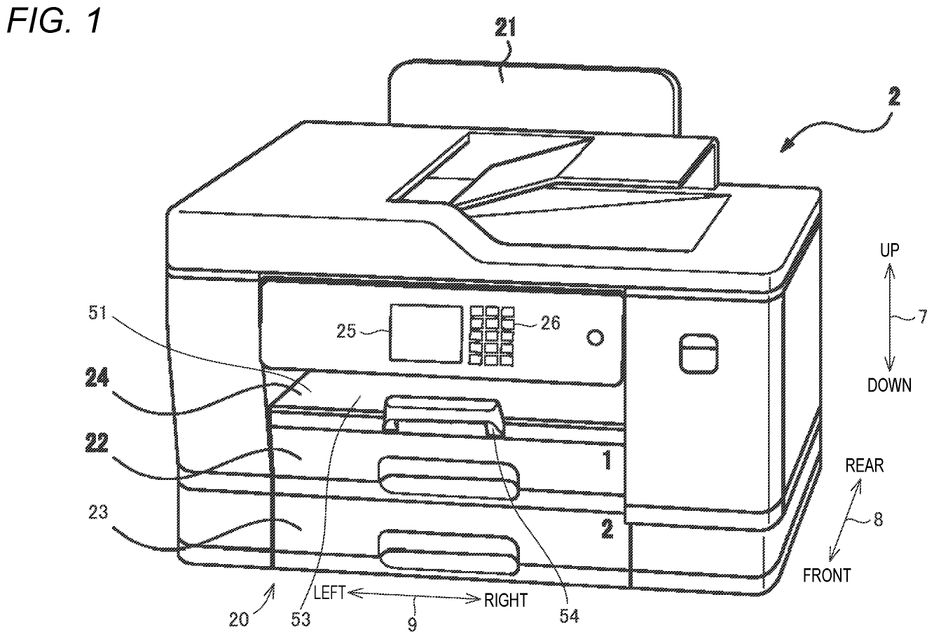

FIG. 1 is an external perspective view of an image recording device 2.

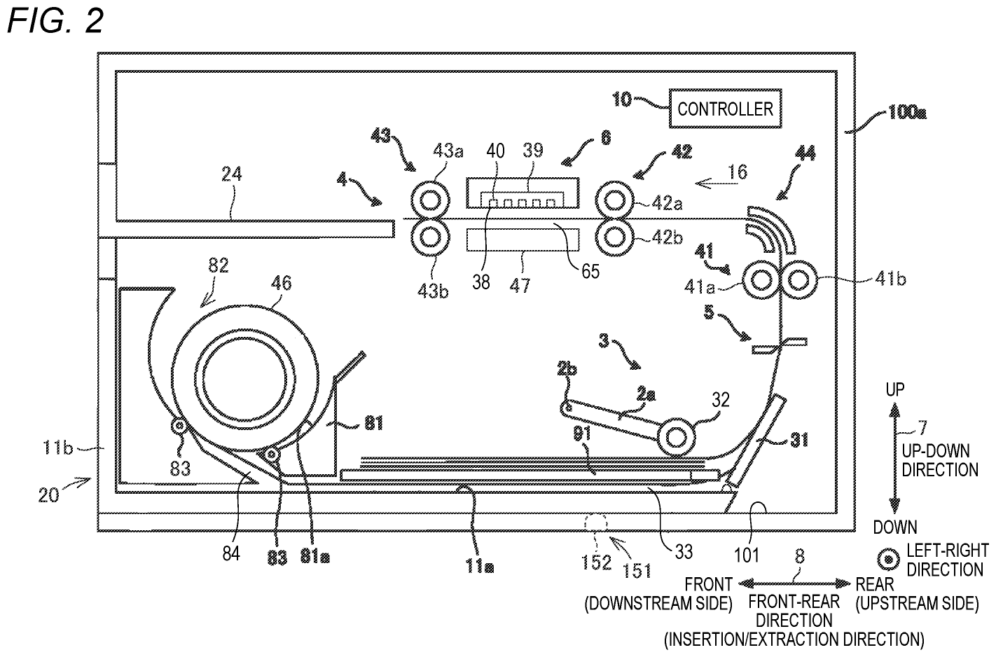

FIG. 2 is a longitudinal sectional view schematically illustrating an internal structure of the image recording device 2.

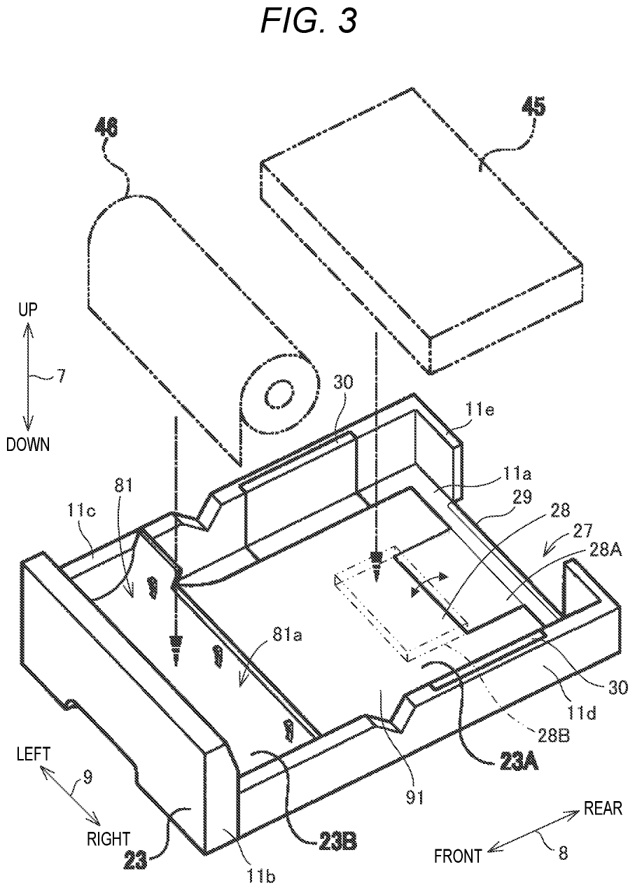

FIG. 3 is a perspective view illustrating a common tray 23.

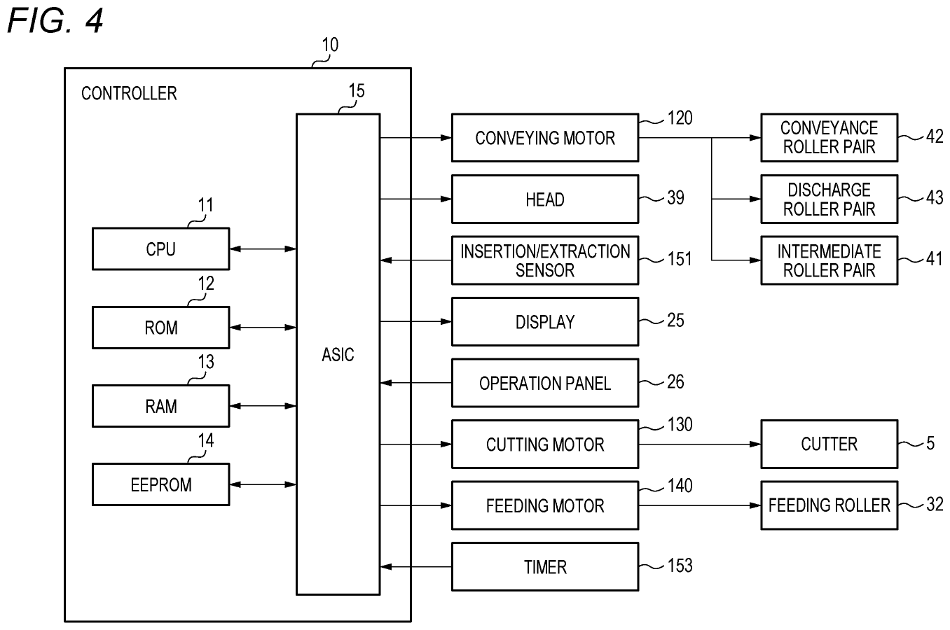

FIG. 4 is a schematic diagram illustrating a controller 10.

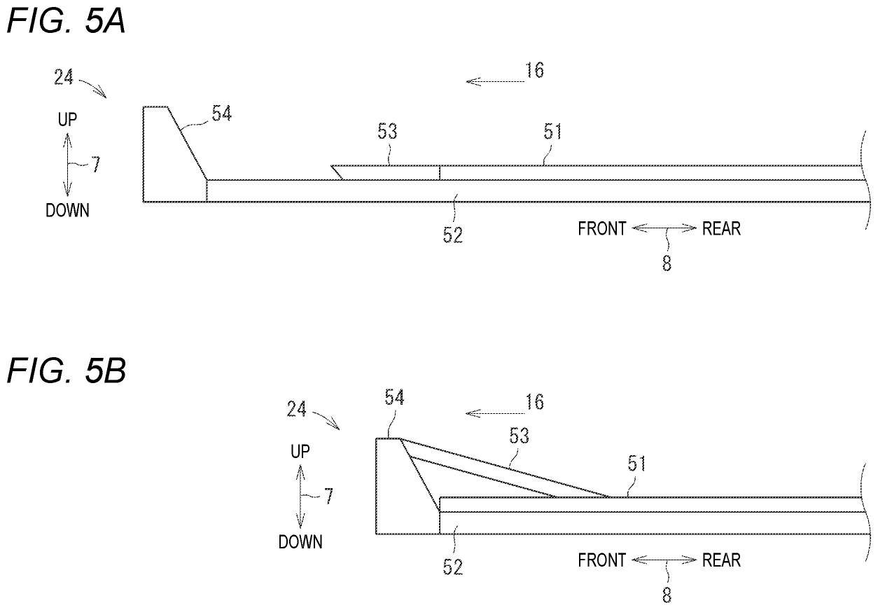

FIG. 5A and FIG. 5B are side views illustrating a discharge tray 24.

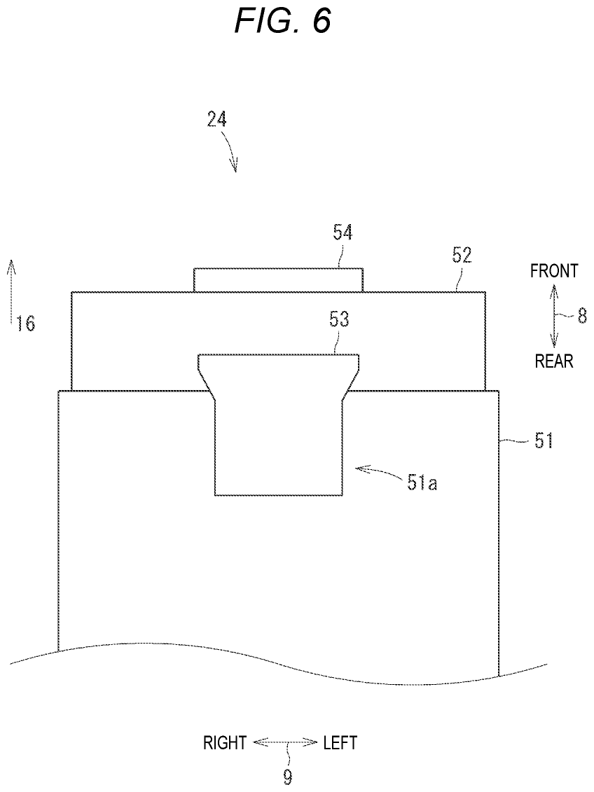

FIG. 6 is a plan view illustrating the discharge tray 24.

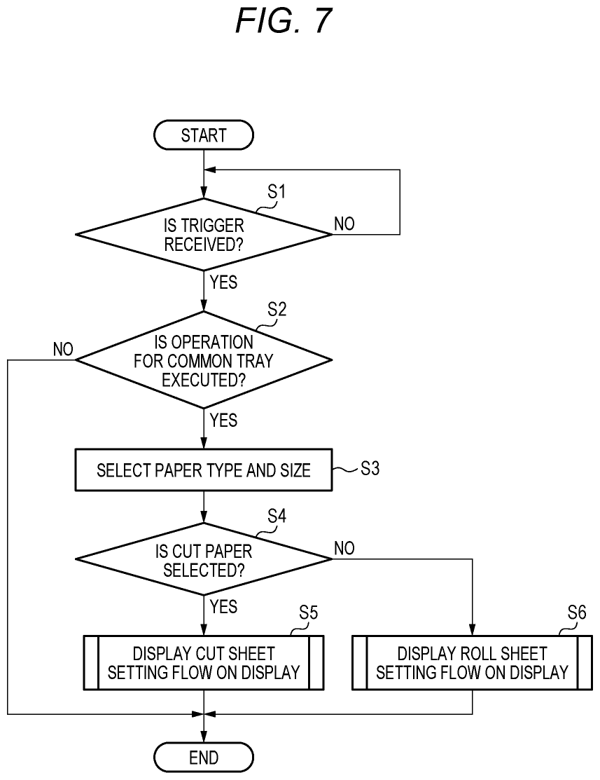

FIG. 7 is a flowchart illustrating a flow of displaying a first guidance or a second guidance on the image recording device 2.

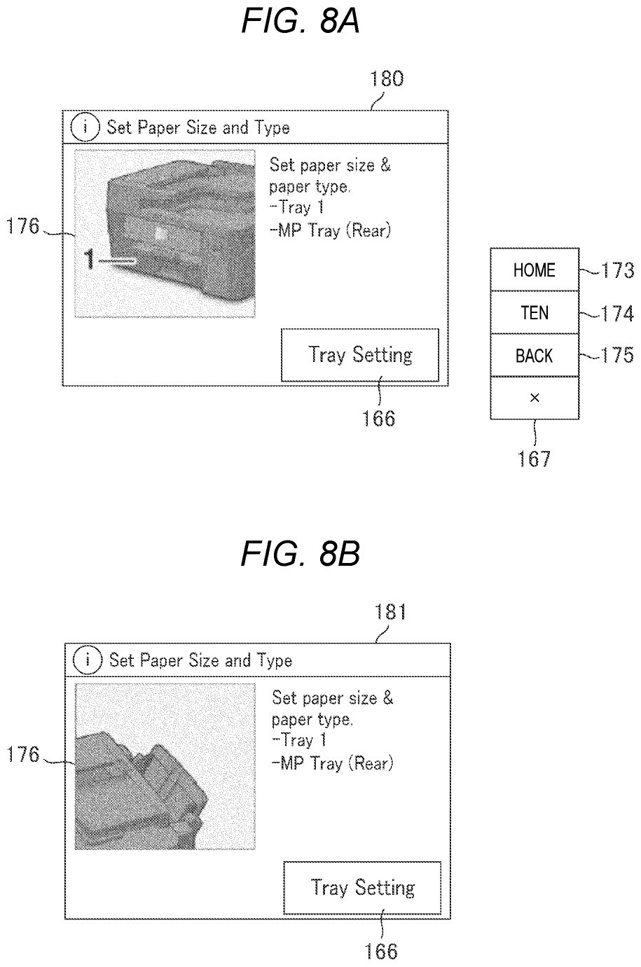

FIG. 8A and FIG. 8B are screen diagrams illustrating examples of a screen displayed on a display 25 at the time of initial setting.

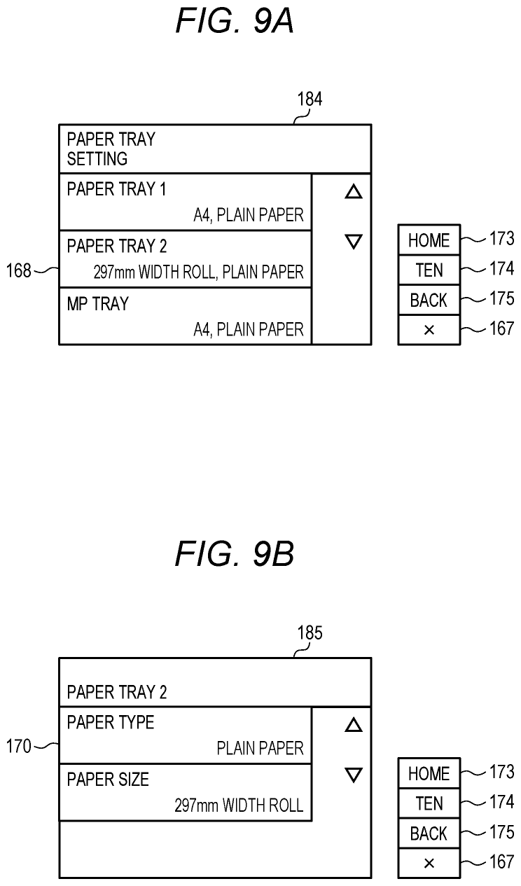

FIG. 9A and FIG. 9B are screen diagrams illustrating examples of a screen displayed on the display 25 when an icon 166 indicating “Tray Setting” in FIG. 8A and FIG. 8B is pressed.

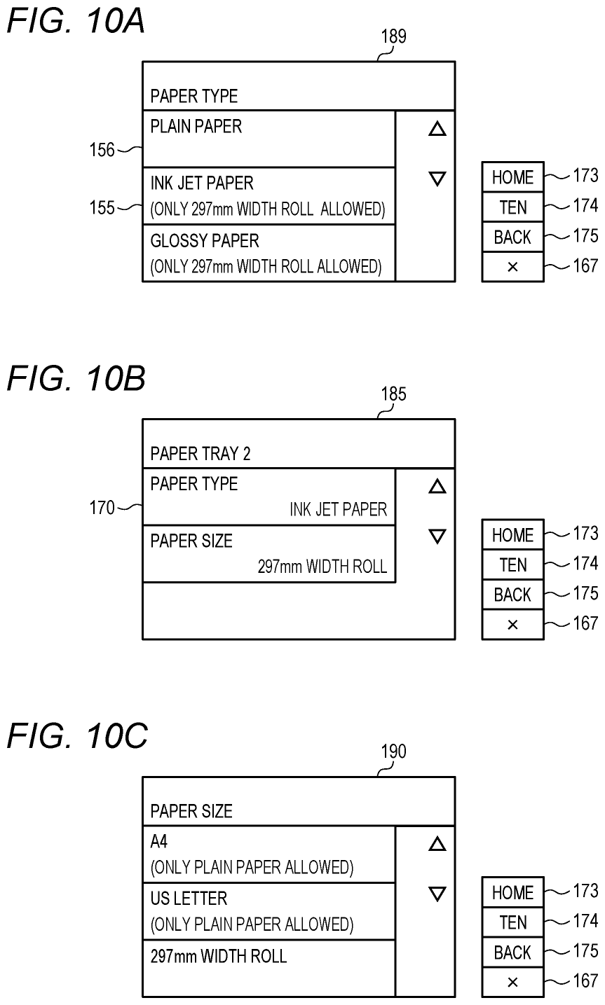

FIG. 10A to FIG. 10C are screen diagrams illustrating examples of a screen for selecting a paper type and a paper size displayed on the display 25.

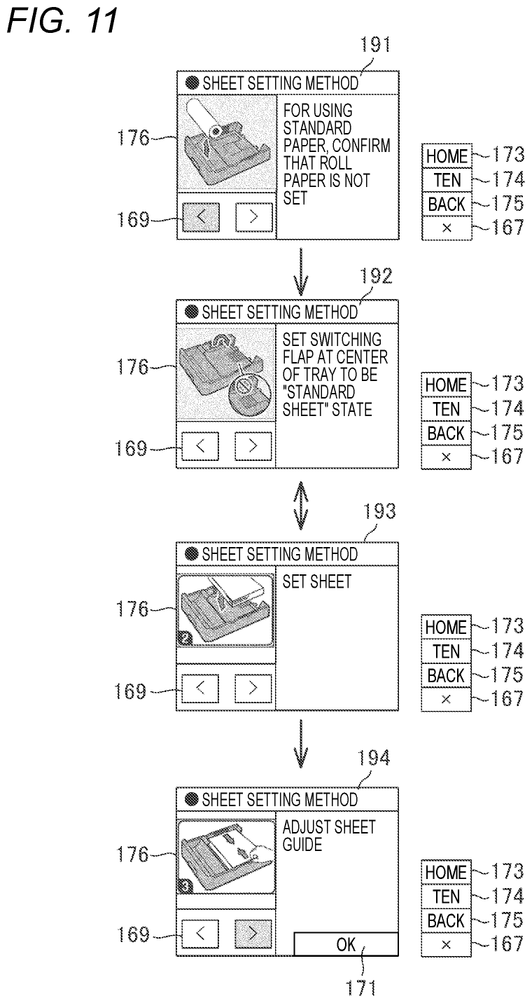

FIG. 11 is a diagram illustrating an example of a transition of screens indicating the first guidance displayed on the display 25.

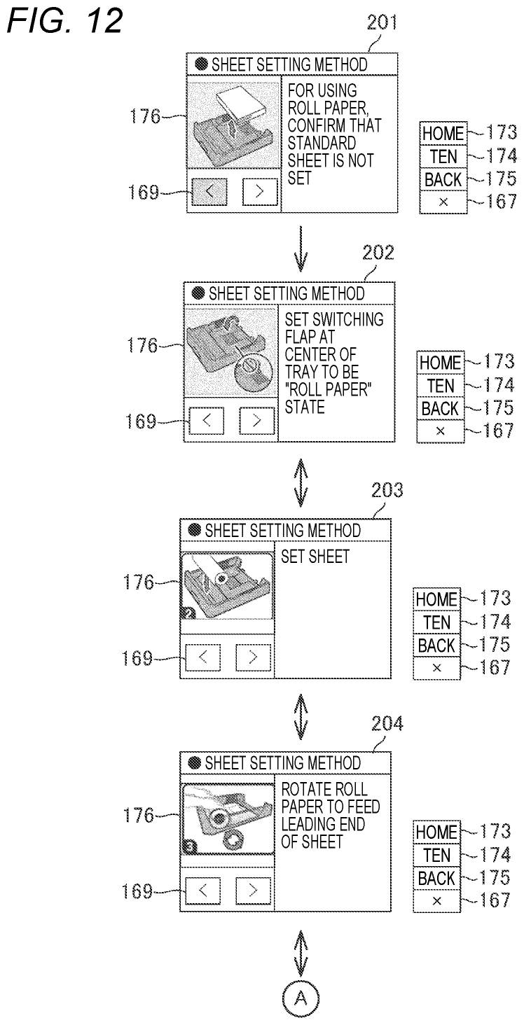

FIG. 12 is a diagram illustrating an example of a transition of screens indicating the second guidance displayed on the display 25.

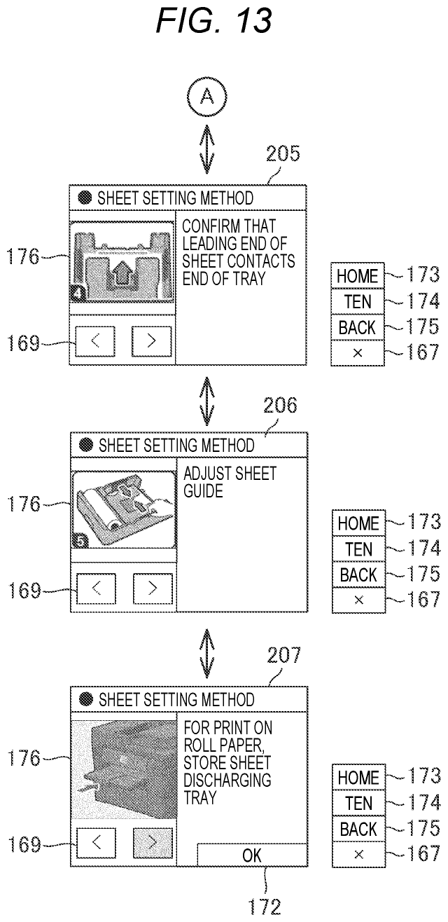

FIG. 13 is a diagram illustrating an example of a transition of screens indicating the second guidance displayed on the display 25.

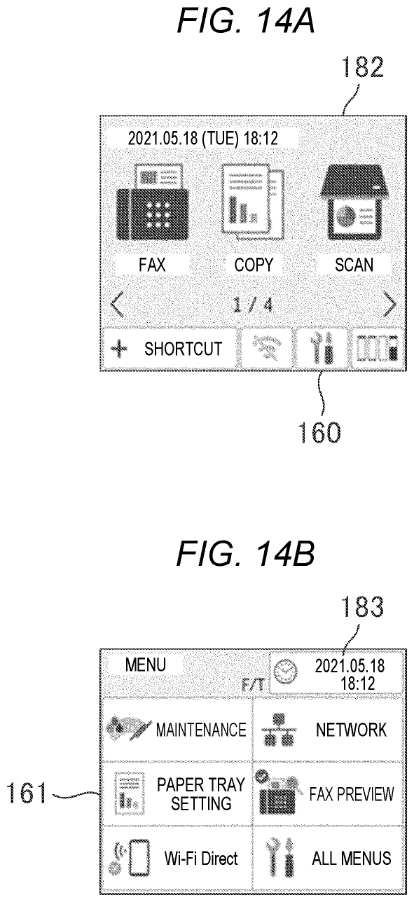

FIG. 14A and FIG. 14B are screen diagrams illustrating examples of a menu screen 183 and a home screen 182 displayed on the display 25.

Hereinafter, an embodiment of the present disclosure will be described. The present embodiment is merely one embodiment of the present disclosure, and it is needless to say that the embodiment can be modified without changing the scope of the present invention. In the following description, an advancement movement from a start point to an end point of an arrow is expressed as an “orientation”, and a unidirectional or bidirectional movement along a line connecting the start point and the end point of the arrow is expressed as a “direction”. In the following description, an up-down direction 7 is defined based on a state in which an image recording device 2 is provided to be usable (a state in FIG. 1). A front-rear direction 8 is defined with a side on which a discharge tray 24 is provided as a near side (a front side). When the image recording device 2 is viewed from the near side (the front side), a left-right direction 9 is defined. In the present embodiment, the word “image” means a recorded object to be recorded on a sheet by ink discharged from a recording unit 6, or a figure drawn on a screen displayed on a display 25. Further, the word “screen” means a display object to be drawn on the display 25 located in the image recording device 2. In the following description, when a roll sheet 46 and a cut sheet 45 are not distinguished from each other, they may be simply referred to as the “sheet”.

### Overall Configuration of Image Recording Device 2

As illustrated in FIG. 1, the image recording device 2 is formed in a substantially rectangular parallelepiped shape. The image recording device 2 is, for example, an ink jet printer, and records an image by ejecting ink onto a sheet. The image recording device 2 includes a housing 100a, a feeding tray 20, a feeding portion 3, a conveying mechanism 4, the discharge tray 24, a cutter 5, the recording unit 6, an operation panel 26, the display 25, and a controller 10. As illustrated in FIG. 2, the housing 100a defines an outer periphery of the image recording device 2.

### Feeding Tray 20

As illustrated in FIG. 1, the feeding tray 20 is located at a lower portion of the image recording device 2. In the present embodiment, the feeding tray 20 refers to the feeding tray 20 including three types of trays. Specifically, the three types of trays included in the feeding tray 20 include a multipurpose tray 21 (hereinafter, also referred to as a MP TRAY), a first tray (PAPER TRAY 1) 22, and a second tray (see FIG. 3, an example of a tray, hereafter, also referred to as PAPER TRAY 2 or a common tray 23). The multipurpose tray 21 refers to the feeding tray 20 that is fixed to the housing 100a of the image recording device 2. The multipurpose tray 21 can feed a plurality of cut sheets (hereinafter, also referred to as the cut sheet 45) from a rear end side of the image recording device 2. The cut sheet 45 is, for example, a sheet cut into a standard size (for example, A4). The cut sheet 45 serves as a first type of sheet. In FIG. 2, the common tray 23 is representatively shown as the feeding tray 20. Further, an insertion/extraction sensor 151 (see FIG. 2) that detects insertion and extraction of the common tray 23 by contacting a lower surface of the common tray 23 is located on a bottom surface 101 of the housing 100a. In other words, the insertion/extraction sensor 151 serves as an example of a sensor configured to detect attachment and detachment of the common tray 23. The extracted state of the feeding tray 20 (the common tray 23) in the present disclosure may include a state in which the feeding tray 20 is completely extracted from the housing 100a or may include a state in which the feeding tray 20 is not completely extracted (that is, partially extracted) from the housing 100a. The insertion/extraction sensor 151 includes, for example, a detector 152 configured to contact the lower surface of the common tray 23 and is pressed downward when the common tray 23 is inserted. The detector 152 is urged upward by an urging member (not shown) and is prevented from coming off from the bottom surface 101. The detector 152 moves upward when the common tray 23 is extracted. The insertion/extraction sensor 151 outputs a signal indicating the insertion or extraction of the common tray 23 (in FIG. 2, a signal indicating that the common tray 23 is inserted) when the detector 152 is pressed, for example.

The first tray 22 and the common tray 23 are trays that can be inserted into and extracted from the housing 100a (see FIG. 2) of the image recording device 2. The first tray 22 is, for example, a tray capable of accommodating the plurality of cut sheets. The common tray 23 is a tray capable of simultaneously accommodating the cut sheet 45 and a sheet wound in a roll shape (hereinafter also referred to as the roll sheet 46). The roll sheet 46 serves as an example of a second type of sheet. That is, the common tray 23 refers to the feeding tray 20 that can be used for both the cut sheet 45 and the roll sheet 46. In the present embodiment, when the image is recorded, the recording is performed in a state in which only a sheet used for the recording of the cut sheet 45 and the roll sheet 46 is accommodated in the common tray 23. The common tray 23 can be inserted into and extracted from the housing 100a of the image recording device 2 in the front-rear direction 8. As illustrated in FIGS. 1 to 3, the common tray 23 is a box having an opening on an upper surface. In the following description, the common tray 23 is mainly described as the feeding tray 20.

As illustrated in FIG. 3, one of the feeding trays 20 can selectively accommodate one of the sheet wound in a roll shape and the cut sheet. In the following description, the feeding tray 20 capable of selectively accommodating the two types of sheets is also referred to as the “common tray 23”. As illustrated in FIG. 3, the common tray 23 includes a bottom surface 11a that faces a main surface in the up-down direction 7 and has a rectangular outer shape in a planar view, and a front wall 11b, a left wall 11c, a right wall 11d, and a rear wall 11e which stand upward from four bottom sides. The rear wall 11e has an opening 27 penetrating the rear wall 11e in the front-rear direction 8. An outer shape of the opening 27 on the rear wall 11e in a side view is rectangular. A width of the rear wall 11e in the left-right direction 9 is larger than that of the cut sheet 45. Therefore, both the roll sheet 46 and the cut sheet 45 can pass through the opening 27 in the front-rear direction 8. As illustrated in FIGS. 2 and 3, the common tray 23 includes a support base 81, a support plate 91, a passage 33, a flap 28 (an example of a switching member), a protrusion 29, and side guides 30.

### Support Base 81

The support base 81 is located at an end portion of the common tray 23 on the front side. The support base 81 has a rectangular parallelepiped shape in which an upper surface 81a is recessed, and both ends thereof in the left-right direction 9 are supported by side surfaces of the right wall 11d and the left wall 11c. A lower surface of the support base 81 is located away from the bottom surface 11a. A recess 82 recessed downward is located on the upper surface 81a of the support base 81. An upper surface of the recess 82 is a circumferential surface recessed downward. A diameter of the upper surface of the recess 82 is larger than an outer diameter of the wound sheet (the roll sheet 46). The roll sheet 46 is placed in the recess 82. The upper surface of the recess 82 is a second region 23B in which the roll sheet 46 is placed.

On the upper surface of the recess 82, a plurality of roller pairs are provided along the left-right direction 9. Each of the roller pairs includes a pair of rollers 83 separated from each other in the front-rear direction 8. Each of the rollers 83 is disposed such that an axial direction of each roller 83 extends along the left-right direction 9. An outer circumferential surface of each of the rollers 83 contacts an outer circumferential surface of the roll sheet 46. The rollers 83 rotate as the roll sheet 46 rotates.

A pull-out hole 84 is located on the upper surface of the recess 82. The pull-out hole 84 extends to both ends of the support base 81 in the left-right direction 9. The pull-out hole 84 extends rearward and downward from the vicinity of a lowermost position on the upper surface of the recess 82, and extends from the upper surface of the recess 82 to a lower surface of the support base 81. An upper end of the pull-out hole 84 is located between the pair of rollers 83. The sheet pulled out from the roll sheet 46 is inserted through the pull-out hole 84. The pull-out hole 84 is a part of the passage 33 to be described later.

### Support Plate 91

The support plate 91 is located between the rear of the support base 81 and the rear wall 11e. An outer shape of the support plate 91 in a planar view is substantially rectangular, and a central portion of a rear end portion in the left-right direction 9 is recessed forward to form a rectangular shape. Left and right ends of the support plate 91 are separated from the left wall 11c and the right wall 11d. A rear end of the support plate 91 is separated from the rear wall 11e. The support plate 91 is separated upward from the lower surface of the common tray 23. A front end of the support plate 91 is connected to a rear surface of the support base 81.

### Passage 33

The passage 33 is located between the support plate 91 and the bottom surface 11a of the common tray 23. The passage 33 extends from the second region 23B to the rear end of the support plate 91. Both ends in the left-right direction 9 and a rear end of the passage 33 are open. A front end of the passage 33 is a connection position between the pull-out hole 84 and the second region 23B. In the passage 33, the sheet inserted through the pull-out hole 84 from the roll sheet 46 reaches the rear end of the support plate 91 through the passage 33.

A dimension of the support plate 91 in the left-right direction 9 is smaller than a dimension of the roll sheet 46 in the left-right direction 9. Left and right ends of the roll sheet 46 are located outside both ends of the support plate 91 in the left-right direction 9.

An upper surface of the support plate 91 is a flat surface. The upper surface of the support plate 91 constitutes a first region 23A in which the cut sheet 45 is placed.

### Flap 28

The flap 28 (an example of the switching member) is located in a recess of the support plate 91. An outer shape of the flap 28 in a planar view is rectangular. Dimensions of the flap 28 in the left-right direction 9 and the front-rear direction 8 are smaller than dimensions of the recess in the left-right direction 9 and the front-rear direction 8, respectively. An end of the flap 28 in the front-rear direction 8 is axially supported to a front end of the recess of the support plate 91 so as to be rotatable upward and in the front-rear direction 8. The flap 28 is rotatable between a first position 28A indicated by a solid line in FIG. 3 and a second position 28B indicated by a two-dot chain line in FIG. 3. That is, the front end of the flap 28 at the first position 28A is axially and rotatably supported to the front end of the recess of the support plate 91. A position of the flap 28 is switched between the first position 28A and the second position 28B based on the type of sheet to be selectively placed. When the cut sheet 45 is placed in the first region 23A, the flap 28 is located at the first position 28A. When the roll sheet 46 is placed in the second region 23B, the flap 28 is located at the second position 28B. The flap 28 at the first position 28A is allowed to contact a feeding roller 32 in a state in which no sheet is placed in the first region 23A. The flap 28 at the second position 28B exposes a part of the passage 33 by opening the recess of the support plate 91. The flap 28 at the second position 28B does not contact the feeding roller 32. In other words, the flap 28 at the second position 28B allows the feeding roller 32 to access the passage 33 without contacting the flap 28.

### Protrusion 29

The protrusion 29 protrudes upward from the bottom surface 11a of the common tray 23. The protrusion 29 is located at a rear end edge of the bottom surface 11a. For example, the protrusion 29 extends in the left-right direction 9 along a position of the opening 27 of the rear wall 11e. An upper surface of the protrusion 29 has, for example, a shape that allows the leading end of the roll sheet 46, which is fed through the passage 33, to ride over. The upper surface of the protrusion 29 has, for example, an arch shape curved in the front-rear direction 8.

### Side Guides 30

Each side guide 30 is a plate whose main surface is oriented in the left-right direction 9. The pair of side guides 30 are located outside both ends of the support plate 91 in the left-right direction 9. Upper ends of the side guides 30 are at substantially the same positions as upper ends of the left wall 11c and the right wall 11d. The side guides 30 are movable in a direction approaching each other or a direction separating from each other along the left-right direction 9. The side guides 30 are moved along the left-right direction 9 in accordance with a width of the sheet in the left-right direction 9, and position the sheet in the left-right direction 9 by contacting left and right ends of the sheet. The pair of side guides 30 are mutually movable by, for example, a rack and pinion mechanism (not shown). The side guides 30 are moved to contact the cut sheet 45 placed in the first region 23A. The side guides 30 are moved to contact the sheet pulled out to the passage 33 from the roll sheet 46 placed in the second region 23B.

### Feeding Portion 3

As illustrated in FIG. 2, the feeding portion 3 is provided above the feeding tray 20 in a state of being attached to the housing 100a. The feeding portion 3 includes the feeding roller 32 (an example of a roller) and a separation piece 31.

### Feeding Roller 32

The feeding roller 32 selectively feeds one of the cut sheet 45 accommodated in the first region 23A and the sheet pulled out from the roll sheet 46 accommodated in the second region 23B.

The feeding roller 32 is axially supported by a tip end of an arm 2a. The arm 2a is rotatably supported by a support shaft 2b. The support shaft 2b is supported by the housing 100a. The arm 2a is urged by an urging member (not shown) such that the feeding roller 32 approaches the flap 28 at the first position 28A. The feeding roller 32 is rotated by driving of a feeding motor 140. When the feeding roller 32 rotates, the sheet contacting the feeding roller 32 is fed rearward.

When the cut sheet 45 is placed in the first region 23A, the feeding roller 32 contacts an upper surface of the cut sheet 45 located at an uppermost position. When the roll sheet 46 is placed in the second region 23B, the feeding roller 32 contacts the sheet pulled out from the roll sheet 46 exposed upward from the recess of the support plate 91.

### Separation Piece 31

The separation piece 31 is a plate that is inclined such that an end portion on the rear side is located above an end portion on the front side. The separation piece 31 is located behind the rear wall 11e of the common tray 23 and at the center in the left-right direction 9 when the common tray 23 is inserted into the housing 100a. The separation piece 31 contacts, for example, a central portion of the cut sheet 45 in a width direction, and separates the cut sheet 45 in a stacked state into the uppermost cut sheet 45 contacting the feeding roller 32 and the cut sheet 45 located therebelow. The uppermost cut sheet 45 separated by the separation piece 31 is guided obliquely upward along a surface of the separation piece 31. The sheet pulled out from the roll sheet 46 is guided obliquely upward along the surface of the separation piece 31.

### Conveying Mechanism 4

The conveying mechanism 4 includes an intermediate roller pair 41, a conveyance roller pair 42, a discharge roller pair 43, and a guide member 44. The intermediate roller pair 41 includes a drive roller 41a that is rotated by the driving of the conveying motor 120 (see FIG. 4), and a driven roller 41b that is rotated together with the drive roller 41a. The intermediate roller pair 41 is located, for example, above the separation piece 31. The conveyance roller pair 42 includes a conveyance roller 42a that is rotated by the driving of the conveying motor 120, and a pinch roller 42b that is rotated together with the conveyance roller 42a. The discharge roller pair 43 includes a discharge roller 43a that is rotated by the driving of the conveying motor 120, and a pinch roller 43b. The conveyance roller pair 42 and the discharge roller pair 43 are located above the feeding tray 20 and are arranged from the rear side to the front side. When the conveying motor 120 is driven under the control of the controller 10, the intermediate roller pair 41 rotates while nipping and holding the sheet therebetween, and conveys the sheet upward. The conveyance roller pair 42 is located behind a head 39. The discharge roller pair 43 is located in front of the head 39. The conveyance roller pair 42 nips and holds the sheet guided forward from above by the guide member 44, and conveys the sheet forward. The discharge roller pair 43 nips and holds the sheet recorded by the recording unit 6, and conveys the sheet forward toward the discharge tray 24. A direction extending upward from the separation piece 31 and extending from the rear side to the front side by the guide member 44 serves as a discharge direction 16 of the sheet.

### Cutter 5

The cutter 5 is located between the separation piece 31 and the intermediate roller pair 41. The cutter 5 includes, for example, a disk-shaped rotary blade and a driven blade. The rotary blade of the cutter 5 is rotated by driving of a cutting motor 130, and the cutter 5 reciprocates along the left-right direction 9. The sheet pulled out from the roll sheet 46 is cut in the left-right direction 9 by the cutter 5 when the cutting motor 130 is driven under the control of the controller 10. The cutter 5 may include a rotary blade and a fixed blade.

### Recording Unit 6

As illustrated in FIG. 2, the recording unit 6 is provided above a conveyance path 65 and between the conveyance roller pair 42 and the discharge roller pair 43 in the discharge direction 16. The head 39 includes a plurality of nozzles 40 on a nozzle surface 38 facing downward. Inks of different colors supplied from ink cartridges (not shown) are ejected from nozzle holes of the respective nozzles 40. A platen 47 that supports a lower surface of the sheet is located below the nozzle surface 38.

### Discharge Tray 24

In the housing 100a, the discharge tray 24 is disposed in front of the head 39 and above the feeding tray 20. As illustrated in FIG. 1, the discharge tray 24 can be accessed from the front of the housing 100a. As illustrated in FIGS. 1, 5A, 5B and 6, the discharge tray 24 includes a first discharge tray 51, a second discharge tray 52, an elevating portion 53, and a stopper 54.

### First Discharge Tray 51

As illustrated in FIGS. 5A, 5B and 6, the first discharge tray 51 is a plate that has a rectangular outer shape in a planar view. Both ends of the first discharge tray 51 in the left-right direction 9 are fixed to the housing 100a. An upper surface of the first discharge tray 51 constitutes a support surface that supports the sheet to be discharged. A recess 51a that is recessed rearward is located at the center of a front end edge of the first discharge tray 51 in the left-right direction 9.

### Second Discharge Tray 52

The second discharge tray 52 is a plate that has a rectangular outer shape in a planar view. The second discharge tray 52 is movable in the front-rear direction 8. The second discharge tray 52 is supported to be slidable in the front-rear direction 8 with respect to the first discharge tray 51. By moving in the front-rear direction 8 with respect to the first discharge tray 51, the second discharge tray 52 can be selectively located at a storage position (a first position, see FIG. 5B) and a pull-out position (a second position, see FIG. 5A). At the storage position, a substantially entire upper surface of the second discharge tray 52 overlaps with an upper surface of the first discharge tray 51 in the up-down direction 7. At the pull-out position, a front end portion of the upper surface of the second discharge tray 52 is located in front of the upper surface of the first discharge tray 51. At the pull-out position, an area overlapping with the first discharge tray 51 in the up-down direction 7 in the upper surface of the second discharge tray 52 is smaller than an area at the storage position. When the roll sheet 46 is used for image recording, the second discharge tray 52 is located at the storage position. When the cut sheet 45 is used for the image recording, the second discharge tray 52 is located at the pull-out position.

### Stopper 54

The stopper 54 is an elongated rod body that extends in the left-right direction 9. The stopper 54 is located at a front end of the second discharge tray 52. The stopper 54 protrudes upward from the upper surface of the second discharge tray 52. A rear surface of the stopper 54 is an inclined surface that faces rearward and upward. The rear surface of the stopper 54 contacts a front end of the cut sheet 45 moving on the upper surface of the second discharge tray 52 in the discharge direction 16. Accordingly, the stopper 54 has a function of holding the cut sheet 45 on the upper surface of the discharge tray 24.

### Elevating Portion 53

The elevating portion 53 is a plate that has a substantially rectangular outer shape in a planar view. The elevating portion 53 is located at the recess 51a of the first discharge tray 51. A rear end of the elevating portion 53 is axially supported by the first discharge tray 51. The elevating portion 53 is rotatable in the up-down direction 7 with respect to the first discharge tray 51. At the pull-out position, the elevating portion 53 is located at a lowered position at which the elevating portion 53 is supported by the upper surface of the first discharge tray 51. At the storage position, the elevating portion 53 is rotated upward by the rear surface of the stopper 54 and is located at a raising position. At the raising position, an upper surface of the elevating portion 53 is inclined rearward and upward. A front end of the elevating portion 53 is located at the same position as or above an upper end of the stopper 54. At the raising position, the roll sheet 46 is conveyed while being supported by the upper surface of the elevating portion 53, and does not contact the rear surface of the stopper 54. As a result, the conveyance of the roll sheet 46 is not hindered by the stopper 54, and thus the occurrence of a paper jam due to the roll sheet 46 is reduced.

### Operation Panel 26

As illustrated in FIG. 1, the operation panel 26 is located at the center of a front surface of the housing 100a. The operation panel 26 is, for example, a push button such as a numeric keypad, and receives an operation input from the user who operates the image recording device 2. The operation panel 26 may be disposed to overlap the display 25, that is, may be combined with or integrated with a so-called touch panel.

### Display 25

The display 25 is located at the center of the front surface of the housing 100a. For example, the display 25 is located adjacent to the operation panel 26 in the left-right direction 9. The display 25 can visually display, for example, an operation state, a setting content, an error, and the like of the image recording device 2 to the user. In the present embodiment, the display 25 can display the first guidance and the second guidance visually indicating methods of accommodating the cut sheet 45 the roll sheet 46, respectively, in the common tray 23.

### Controller 10

As illustrated in FIG. 4, the controller 10 includes a CPU 11, a ROM 12, a RAM 13, an EEPROM 14, and an ASIC 15, which are connected by an internal bus. The ROM 12 stores programs and the like for controlling various operations of the CPU 11. The RAM 13 is used as a storage area for temporarily storing data, signals, and the like to be used when the CPU 11 executes the programs described above, or as a work area for data processing. The EEPROM 14 stores settings, flags, and the like to be held even after a power supply is turned off.

The conveying motor 120, the cutting motor 130, and the feeding motor 140 are connected to the ASIC 15.

The ASIC 15 generates a drive signal for causing each motor to rotate, and controls each motor based on the drive signal. Each motor rotates forward or backward according to the drive signal from the ASIC 15. The controller 10 controls the driving of the conveying motor 120 to drive the drive roller 41a, the conveyance roller 42a, and the discharge roller 43a. The controller 10 controls the driving of the cutting motor 130 to drive the cutter 5. The controller 10 controls driving of the feeding motor 140 to drive the feeding roller 32.

The insertion/extraction sensor 151 (an example of a sensor), the display 25, and the operation panel 26 are connected to the ASIC 15. The insertion/extraction sensor 151 detects the insertion and extraction of the feeding tray 20 with respect to the housing 100a. The insertion/extraction sensor 151 outputs an insertion/extraction signal to the controller 10 according to a detection result. The display 25 displays the operation state, the setting content, the first guidance, the second guidance, and the like of the image recording device 2. The operation panel 26 outputs an operation signal corresponding to an operation by the user to the controller 10.

The insertion/extraction sensor 151 and a timer 153 are electrically connected to the ASIC 15. The controller 10 detects the insertion and extraction of the feeding tray 20 via the insertion/extraction sensor 151. For example, the controller 10 detects whether the feeding tray 20 is located at an insertion position via the insertion/extraction sensor 151. The controller 10 detects a feeding error when the sheet is not fed from the feeding tray 20. The timer 153 is a so-called clock, and measures, for example, a time elapsed after each screen is displayed. The timer 153 sends a time measurement result to the controller 10. Although the description is omitted, the ASIC 15 may be connected to a rotary encoder that detects rotation of the drive roller 41a and the like, a linear encoder that detects a position of the recording unit 6 in the left-right direction 9, and the like.

The EEPROM 14 stores setting information set by the user. The setting information includes, for example, the types of sheets set in the multipurpose tray 21, the first tray 22, and the common tray 23, the presence or absence of an initial setting flag, identification information on the multipurpose tray 21, the first tray 22, and the common tray 23 selected for the image recording, and the like.

The EEPROM 14 stores a flag indicating whether an initial setting of the image recording device 2 is executed. The initial setting is a setting operation that needs to be performed first in order to use the image recording device 2 when the image recording device 2 is initially operated and settings thereof are initialized. The initial setting includes setting of the type and the kind of the sheet accommodated in the feeding tray 20, updating of an application installed in the image recording device 2, and the like. The EEPROM 14 stores an initial setting screen.

The EEPROM 14 stores various screens for guiding the setting of the sheet accommodated in the common tray 23 and programs. The EEPROM 14 stores, for example, the first guidance indicating a procedure of placing a plurality of cut sheets 45 in the first region 23A of the common tray 23 and the second guidance indicating a procedure of placing the roll sheet 46 in the second region 23B of the common tray 23. Further, the EEPROM 14 stores various screens for guiding the user to the first guidance and the second guidance. The EEPROM 14 stores, as the various screens, a home screen 182 (see FIG. 14A), a menu screen 183 (see FIG. 14B), the initial setting screen, a paper tray setting screen (a screen 184, see FIG. 9A), a setting screen for PAPER TRAY 2 (a screen 185, see FIG. 9B and FIG. 10B), a screen indicating a tray setting error, a paper type screen (a screen 189, see FIG. 10A), and the like. The EEPROM 14 stores display information indicating a display time of each screen. The EEPROM 14 stores programs for operating the image recording device 2 to guide the user to various screens.

### Display Operations of First Guidance and Second Guidance by Image Recording Device 2

Hereinafter, display operations of the first guidance and the second guidance by the image recording device 2 will be described.

As illustrated in FIG. 7, in the image recording device 2 in a state in which the power supply is turned on, the controller 10 receives a trigger that calls setting for the common tray 23. The trigger is, for example, an input to start paper setting with respect to the common tray 23, extraction detection of the common tray 23, execution of the initial setting, and detection of a sheet supply error from the common tray 23.

Hereinafter, a case in which the trigger is the initial setting will be described. In step S1, the controller 10 determines whether the initial setting is executed. Specifically, the controller 10 reads a flag related to the initial setting from the EEPROM 14. When the read flag related to the initial setting is 0 (False), the controller 10 determines that the initial setting is not executed, that is, the trigger is received (step S1_YES). The controller 10 changes the initial setting flag to 1 (True) and stores the initial setting flag in the EEPROM 14. When the read flag related to the initial setting is 1 (True) (step S1_NO), the controller 10 waits until another trigger is received.

In step S2, the controller 10 displays a screen 180 illustrated in FIG. 8A on the display 25. When the icon 166 indicating the “Tray Setting” on the screen 180 is selected and executed, the controller 10 displays the screen 184 illustrated in the upper portion in FIG. 9A on the display 25. In step S2, the screen 180 illustrated in FIG. 8A and the screen 181 illustrated in FIG. 8B may be displayed alternately. The screen 180 includes an image mainly indicating a front part of the image recording device 2, and the screen 181 includes an image mainly indicating a rear part of the image recording device 2.

When an icon 168 indicating “PAPER TRAY 2” is selected and executed on the screen 184 illustrated in FIG. 9A, the controller 10 determines that an operation for the common tray 23 is executed (step S2_YES), and the process proceeds to step S3. When an icon indicating “PAPER TRAY 1” or “multipurpose tray” is selected and executed, or when an icon 167 with a “x” mark for receiving an input for ending the guidance is selected and executed on the screen 184, the controller 10 determines that a corresponding operation is not the operation for the common tray 23 (step S2_NO), and the process according to this flow ends.

In step S3, the controller 10 receives a selection input of a paper type and a paper size. The controller 10 displays the screen 185 (an example of a sheet input screen) indicating the setting of PAPER TRAY 2 illustrated in FIG. 9B on the display 25. When an icon 170 indicating “paper type” is selected and executed on the screen 185, the controller 10 displays the screen 189 for selecting the paper type illustrated in FIG. 10A on the display 25.

For example, when an icon 155 indicating “ink jet paper” is selected and executed on the screen 189, the controller 10 displays the screen 185 indicating the setting of PAPER TRAY 2 illustrated in FIG. 10B on the display 25. In the present embodiment, there is the setting that only roll paper having a width of 297 mm can be selected as the ink jet paper and cut paper cannot be selected as the ink jet paper, and thus when the “ink jet paper” is selected, it is displayed on the screen 185 that the ink jet paper is set as the paper type and the roll paper having the width of 297 mm is set as the paper size.

For example, when an icon 156 indicating “plain paper” is selected and executed on the screen 189, the controller 10 displays a screen 190 for selecting the paper size illustrated in FIG. 10C on the display 25. In the present embodiment, both the cut paper and the roll paper can be selected as the plain paper, and thus cut paper having “A4 size”, cut paper having “US letter size”, and the roll paper having the “width of 297 mm” can be selected on the screen 190.

In step S4, the controller 10 determines whether the cut paper is selected. When the cut paper is selected (step S4_YES), the process proceeds to step S5. When the cut paper is not selected, that is, when the roll paper is selected (step S4_NO), the controller 10 proceeds the process to step S6. A state in which the cut paper is selected is an example of input reception of the type of sheet placed in the first region 23A. A state in which the roll paper is selected is an example of input reception of the type of sheet placed in the second region 23B.

As illustrated in FIGS. 11 to 13, on the left side of each screen constituting the first guidance or the second guidance, components of the image recording device 2 and an image (object) 176 of the cut paper or the roll paper are shown. At a lower left corner of the screen, arrow icons 169 for receiving an input for switching the screen forth and back are shown. At the center of the screen, text for guiding an accommodation method is shown. At a lower right corner of the screen, the icon 167 with the “x” mark for receiving an input for ending the guidance is shown. For example, in the image recording device 2, the controller 10 displays, on the display 25, the icon 167 with the “x” mark that is effective when there is a task of recording an image on a sheet (when the task remains). When the icon 167 with the mark “x” is selected and executed, the controller 10 cancels the task and displays the home screen 182 (see FIG. 14A) on the display 25.

At the lower right corner of the screen, an icon 173 for switching to the home screen 182 that is effective when there is no task in the image recording device 2, an icon 174 for displaying a numeric keypad on the display 25, an icon 175 for returning back to a previous screen, and the like are also displayed. An input and the like with respect to the arrow icons 169 and the icon 167 is received when the icon displayed on the display 25 is selected by reverse display or the like via an operation key of the operation panel 26 and an execution key is operated.

### Display of First Guidance

In step S5, the controller 10 displays the first guidance for accommodating the cut sheet 45 in the common tray 23 on the display 25. The first guidance includes four screens 191 to 194. On the screens 191 to 194, the two arrow icons 169 indicating either the right or the left are displayed, and the controller 10 sequentially switches the screens 191 to 194 in response to selection and execution of any one of the arrow icons 169.

As illustrated in FIG. 11, the controller 10 displays, on the display 25, the screen 191 for taking out the roll sheet 46 from the common tray 23 as a first screen of the first guidance. As a second screen, the controller 10 displays, on the display 25, the screen 192 for moving the flap 28 to a first state (the first position 28A). As a third screen, the controller 10 displays, on the display 25, the screen 193 for setting the cut sheet 45 in the first region 23A of the common tray 23. As a fourth screen, the controller 10 displays, on the display 25, the screen 194 for moving the side guides 30 to contact both ends of the cut paper in the left-right direction 9. The screens 191 to 194 include an image in which the first region 23A and the second region 23B are distinguishable from each other in the common tray 23. The screens 191, 193, and 194 include an image by which the sheet can be identified as the cut paper or the roll paper (that is, an image indicating the type of sheet). The screen 191 is an example of a screen on which the roll paper is not placed in the second region 23B. When the icon 171 indicating “OK” is selected and executed on the screen 194, the controller 10 ends the display of the first guidance on the display 25.

### Display of Second Guidance

In step S6, the controller 10 displays, on the display 25, the second guidance for accommodating the roll sheet 46 in the common tray 23. The second guidance includes seven screens, that is, screens 201 to 207. The arrow icons 169 are displayed on the screens 201 to 207, and the controller 10 sequentially switches the screens 201 to 207 in response to the selection and execution of any one of the arrow icons 169.

As illustrated in FIG. 12, the controller 10 displays, on the display 25, the screen 201 for taking out the cut sheet 45 from the common tray 23 as a first screen of the second guidance. As a second screen, the controller 10 displays, on the display 25, the screen 202 for moving the flap 28 to a second state (the second position 28B). As a third screen, the controller 10 displays, on the display 25, the screen 203 for setting the roll sheet 46 in the second region 23B of the common tray 23. As a fourth screen, the controller 10 displays, on the display 25, the screen 204 for rotating the roll sheet 46 and pulling out the leading end of the roll sheet 46 rearward.

As illustrated in FIG. 13, as a fifth screen, the controller 10 displays, on the display 25, the screen 205 for bringing the leading end of the roll sheet 46 pulled out into contact with the protrusion 29. As a sixth screen, the controller 10 displays, on the display 25, the screen 206 for moving the side guides 30 to contact both ends of the roll sheet 46 in the left-right direction 9. As a seventh screen, the controller 10 displays, on the display 25, the screen 207 indicating that the second discharge tray 52 is moved in a direction opposite to the discharge direction 16. The screens 201 to 207 include an image in which the first region 23A and the second region 23B are distinguishable from each other in the common tray 23. The screens 201, 203, 204, 205 and 206 include an image by which the sheet can be identified as the cut paper or the roll paper (that is, an image indicating the type of sheet). The screen 201 is an example of a screen on which the cut paper is not placed in the first region 23A. When the icon 172 indicating “OK” is selected and executed on the screen 207, the controller 10 ends the display of the second guidance on the display 25.

In addition, after the initial setting is executed, the trigger becomes an operation from a menu of the home screen 182 and an extraction detection of the common tray 23 by the insertion/extraction sensor 151.

For example, in step S2, the controller 10 determines whether a setting screen of the common tray 23 is called. When the power supply of the image recording device 2 is turned on, the controller 10 displays the home screen 182 illustrated in FIG. 14A on the display 25. When a setting icon 160 located at a lower right corner of the home screen 182 is selected and executed, the controller 10 displays the menu screen 183 illustrated in FIG. 14B on the display 25. When a paper tray setting icon 161 is selected and executed on the menu screen 183, the controller 10 displays the screen 184 described above on the display 25. Thereafter, steps S3 to S6 described above are executed.

For example, in step S1, it is determined whether the common tray 23 is extracted. The controller 10 acquires the signal output from the insertion/extraction sensor 151 and then determines that the common tray 23 is extracted. When determining that the common tray 23 is extracted, the controller 10 displays the screen 184 described above on the display 25. Thereafter, steps S3 to S6 described above are executed.

In these case, in the first guidance or the second guidance, the controller 10 acquires, from the timer 153, an elapsed time from a timing (a time point) at which the screens 191 to 194 or the screens 201 to 207 are started to be displayed on the display 25 (for example, a time elapsed without an operation from the start of the display), and displays the home screen 182 on the display 25 when a first time elapses. In the present embodiment, the first time is set to 180 seconds. In addition, the controller 10 acquires, from the timer 153, an elapsed time from a timing at which the screen 185 is started to be displayed on the display 25 (for example, a time elapsed without an operation from the start of the display), and displays the home screen 182 on the display 25 when a second time elapses. In the present embodiment, the second time is set to 60 seconds. That is, the first time is longer than the second time.

### Effects of Embodiment

According to the present embodiment, regarding the common tray 23 on which both the plurality of cut sheets 45 and the roll sheet 46 can be placed, the screens 191 to 194 and 201 to 207 indicating which of the first region 23A and the second region 23B the cut paper or the roll paper is to be placed in are displayed on the display 25. By visually indicating which of the first region 23A and the second region 23B the cut paper or the roll paper is to be placed in, the user can easily grasp the place at which the cut paper or the roll paper is placed.

Since the first guidance indicating the procedure of placing the cut paper in the first region 23A is displayed on the display 25, the user can easily grasp the place at which the cut paper is placed.

Since the second guidance indicating the procedure of placing the roll paper in the second region 23B is displayed on the display 25, the user can easily grasp the place at which the roll paper is placed.

The screens 192 and 202 provide an appropriate guide for determining the position of the flap 28 according to the type of sheet to be placed in the common tray 23.

The screens 193 and 203 provide an appropriate guide for selectively placing the cut paper or the roll paper.

In accordance with the screen 194, occurrence of a misalignment in the supply of the cut sheet 45 placed in the first region 23A is reduced by the side guides 30.

In accordance with the screen 206, occurrence of a misalignment in the supply of the roll sheet 46 placed in the second region 23B is reduced by the side guides 30.

In accordance with the screen 207, the second discharge tray 52 is moved, so that it is possible to reduce occurrence of prevention of discharge of the roll sheet 46 caused by the roll sheet 46 being caught by the first discharge tray 51 and the second discharge tray 52.

The first guidance or the second guidance is visually guided in response to the state, as a trigger, that the common tray 23 is removed and the first region 23A and the second region 23B can be accessed from the outside.

The first time for returning back to the home screen 182 from the screens 191 to 194 and 201 to 207 in the first guidance and the second guidance is longer than the second time for returning back to the home screen 182 from the screen 185, and thus the screens 191 to 194 and 201 to 207 are easily confirmed.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

In the present embodiment, the ink jet paper and glossy paper, which are the paper types selectable on the screen 189, correspond to only the roll paper, and similarly to the plain paper, the ink jet paper and the glossy paper may be selectable as the cut paper or the roll paper.

In addition, the trigger may be something other than the initial setting, the operation from the menu of the home screen 182, and the extraction detection of the common tray 23 by the insertion/extraction sensor 151. For example, when the setting of the paper on the screen 185 is different from the type of sheet detected in the image recording, the first guidance or the second guidance may be displayed on the display 25.

After the display of the second guidance guided with the fact that the common tray 23 is extracted as the trigger, the controller 10 may display, on the display 25, a screen that warns of the misalignment of the roll sheet 46, which may occur when the common tray 23 is extracted. For example, the controller 10 may display, on the display 25, a warning “when the tray is extracted, the roll paper may float or the leading end of the paper may be out of alignment. At this time, please reset the roll paper”.

In addition, in the embodiment described above, the sheet may be a paper sheet, a cloth, or a film. The common tray 23 may be a tray in which the first region 23A and the second region 23B exclusively exist. The common tray 23 may be, for example, a tray in which the first region 23A and the second region 23B partially overlap each other in the front-rear direction 8 or the left-right direction 9, and the cut sheet 45 can be set by removing the support base 81.

Further, the second discharge tray 52 is set to be supported by the first discharge tray 51, but the present disclosure is not limited thereto. The second discharge tray 52 may be supported by the housing 100a independently of the first discharge tray 51.

In addition, the common tray 23 may be a tray in which the first region 23A and the second region 23B overlap each other and that can selectively accommodate one of the cut sheet 45 and the roll sheet 46.

In addition, the side guides 30 are set to contact the sheet pulled out to the passage 33 from the roll sheet 46 placed in the second region 23B, but the present disclosure is not limited thereto. The side guides 30 may be moved to contact a main body (a wound portion) of the roll sheet 46.

What is claimed is:

1. An image recording device comprising:
a housing;
a tray configured to be attached to and detached from the housing;
a recording device configured to record an image on a sheet supplied from the tray;
a display; and
a controller,
wherein the tray comprises:
a first region configured to allow at least one first type of sheet to be placed therein; and
a second region configured to allow a second type of sheet to be placed therein, the second type of sheet being different from the first type of sheet and prepared in a rolled state, and
wherein the controller is configured to execute a process of causing the display to display thereon a sheet placing screen indicating which of the first region and the second region the sheet is to be placed in.

2. The image recording device according to claim 1, wherein the controller is configured to execute a process of causing the display to display thereon a first guidance indicating a procedure of placing the at least one first type of sheet in the first region.

3. The image recording device according to claim 1, wherein the controller is configured to execute a process of causing the display to display thereon a second guidance indicating a procedure of placing the second type of sheet in the second region.

4. The image recording device according to claim 1, wherein the controller is configured to:
execute, in response to reception of a trigger signal, a process of causing the display to display thereon a sheet input screen for receiving an input designating a type of sheet;
execute, in response to reception of an input designating the first type, a process of causing the display to display thereon a first guidance indicating a procedure of placing the at least one first type of sheet in the first region; and
execute, in response to reception of an input designating the second type, a process of causing the display to display thereon a second guidance indicating a procedure of placing the second type of sheet in the second region.

5. The image recording device according to claim 4, further comprising:
a roller configured to supply the sheet from the tray,
wherein the tray comprises:
a support plate located in the first region and defining a passage below the support plate, the passage extending from the second region; and
a switching member supported by the support plate and configured to move between a first position and a second position, the second position at which the switching member exposes a part of the passage,
wherein when no sheet is placed in the first region, the switching member at the first position allows the roller to contact the switching member, and the switching member at the second position allows the roller to access the passage without contacting the switching member,
wherein the first guidance comprises a screen indicating that the switching member is located at the first position, and
wherein the second guidance comprises a screen indicating that the switching member is located at the second position.

6. The image recording device according to claim 4,
wherein the tray comprises: a support plate located in the first region and defining a passage below the support plate, the passage extending from the second region, and
wherein the second guidance comprises a screen indicating that a leading end of the second type of sheet enters the passage.

7. The image recording device according to claim 2, wherein the first guidance comprises a screen indicating that no sheet is placed in the second region.

8. The image recording device according to claim 3, wherein the second guidance comprises a screen indicating that no sheet is placed in the first region.

9. The image recording device according to claim 2,
wherein the tray comprises a side guide configured to move in a direction intersecting a direction in which the sheet is supplied, the side guide being configured to contact the first type of sheet placed in the first region, and
wherein the first guidance comprises a screen indicating that the side guide is moved.

10. The image recording device according to claim 6,
wherein the tray comprises a protrusion that is located at an end portion of the tray in a supply direction of the sheet and protrudes upward, and
wherein the second guidance comprises a screen indicating that the leading end of the second type of sheet, which has entered the passage, contacts the protrusion.

11. The image recording device according to claim 3,
wherein the tray comprises a side guide configured to move in a direction intersecting a direction in which the sheet is supplied, the side guide being configured to contact the second type of sheet, and
wherein the second guidance comprises a screen indicating that the side guide is moved.

12. The image recording device according to claim 3, further comprising:
a first discharge tray configured to support the sheet on which the image is recorded; and
a second discharge tray configured to move in a discharge direction of the sheet with respect to the first discharge tray,
wherein the second guidance comprises a screen indicating that the second discharge tray is moved in a direction opposite to the discharge direction.

13. The image recording device according to claim 4, further comprising:
a sensor configured to detect attachment and detachment of the tray,
wherein the trigger signal comprises a signal from the sensor indicating that the tray is detached.

14. The image recording device according to claim 4,
wherein each of the first guidance and the second guidance comprises a plurality of screens,
wherein the controller is configured to:
execute a process of measuring a first elapsed time after a screen included in the first guidance or the second guidance is displayed on the display and a second elapsed time after the sheet input screen is displayed on the display, and
execute, in response to the first elapsed time reaching a first predetermined time or the second elapsed time reaching a second predetermined time, a process of causing the display to display thereon a screen displayed before the trigger signal is received on the display, and
wherein the first predetermined time is longer than the second predetermined time.

15. The image recording device according to claim 1, wherein the sheet placing screen comprises an image indicating a type of sheet and an image indicating the tray in which the first region and the second region are drawn.
